(19) United States
(12) Patent Application Publication
(10) Pub. No.: US 2024/0155744 A1
(43) Pub. Date: May 9, 2024

(54) HEATING COOKER, COMPUTER PROGRAM, AND HEATING COOKING METHOD

(71) Applicant: SHARP KABUSHIKI KAISHA, Osaka (JP)

(72) Inventors: KEIGO NAKAMURA, Osaka (JP); KAORU TOMISHIGE, Osaka (JP)

(21) Appl. No.: 18/241,818

(22) Filed: Sep. 1, 2023

(30) Foreign Application Priority Data
Nov. 4, 2022 (JP) 2022-177165

(51) Int. Cl. H05B 6/64; H05B 1/02; H05B 3/74

(52) U.S. Cl. CPC H05B 6/647; H05B 1/0263; H05B 1/0266; H05B 3/74; H05B 2213/07

(57) ABSTRACT

A heating cooker includes a heating unit, a plate, an operation unit, a control unit, and a communication unit. The heating unit heats a first object to be heated. The plate is provided above the heating unit and the first object to be heated is to be placed on the plate. Operation information is input through the operation unit. The control unit controls the heating unit based on the operation information. The communication unit wirelessly communicates with an external device. The control unit controls the communication unit to transmit drive information to the external device. The drive information includes a drive state of the heating unit.

### CROSS-REFERENCE TO RELATED APPLICATIONS

This application claims the benefit of priority to Japanese Patent Application Number 2022-177165 filed on Nov. 4, 2022. The entire contents of the above-identified application are hereby incorporated by reference.

### BACKGROUND

### Technical Field

The disclosure relates to a heating cooker, a computer program, and a heating cooking method.

JP 2011-192659 A discloses a heating cooker. The heating cooker disclosed in JP 2011-192659 A includes an induction heating unit, a glass top plate, and a light-emitting display unit. The induction heating unit includes an induction heating coil. The top plate is provided above the induction heating unit and an object to be heated is to be placed on the top plate. The light-emitting display unit is provided at the top plate and displays an operating state of the induction heating unit.

### SUMMARY

In the heating cooker disclosed in JP 2011-192659 A, the cook cannot see the light-emitting display unit unless being near the heating cooker during cooking. As a result, the cook cannot leave the heating cooker during cooking.

In view of the above problem, it is an object of the disclosure to provide a heating cooker, a computer program, and a heating cooking method that allow the cook to identify the state of the heating cooker even if being away during cooking.

According to an aspect of the present application, a heating cooker includes a heating unit, a plate, an operation unit, a control unit, and a communication unit. The heating unit is configured to heat a first object to be heated. The plate is provided above the heating unit, the first object to be heated being to be placed on the plate. Operation information is input through the operation unit. The control unit is configured to control the heating unit based on the operation information. The communication unit is configured to wirelessly communicate with an external device. The control unit controls the communication unit to transmit drive information to the external device. The drive information includes a drive state of the heating unit.

According to an aspect of the present application, a non-transitory computer-readable recording medium stores a computer program, the computer program being configured to cause a computer to perform receiving the drive information of the heating cooker described above and displaying the drive information.

According to an aspect of the present application, a heating cooking method is a heating cooking method for a heating cooker including a heating unit configured to heat a first object to be heated and a plate provided above the heating unit, the first object to be heated being to be placed on the plate, the heating cooking method including inputting operation information to the heating cooker, controlling the heating unit based on the operation information, and transmitting drive information to an external device from the heating cooker, wherein the drive information includes a drive state of the heating unit.

According to the heating cooker, the computer program, and the heating cooking method of the disclosure, the cook can identify the state of the heating cooker even if being away during cooking.

### BRIEF DESCRIPTION OF DRAWINGS

The disclosure will be described with reference to the accompanying drawings, wherein like numbers reference like elements.

FIG. 1 is a diagram illustrating a microwave/grill system according to the present embodiment.

FIG. 2 is a plan view illustrating an appearance of a microwave/grill apparatus according to the present embodiment.

FIG. 3 is a diagram illustrating a rear side of an operation unit according to the present embodiment.

FIG. 4 is a block diagram illustrating a configuration of the microwave/grill apparatus according to the present embodiment.

FIG. 5 is a block diagram illustrating a configuration of a smartphone according to the present embodiment.

FIG. 6 is a diagram illustrating an example of a display image displayed on the smartphone according to the present embodiment.

FIG. 7 is a diagram illustrating an example of a display image displayed on the smartphone according to the present embodiment.

FIG. 8 is a flowchart for explaining a heating cooking method using the microwave/grill apparatus according to the present embodiment.

### DESCRIPTION OF EMBODIMENTS

An embodiment of a microwave/grill system according to the disclosure will be described below with reference to the drawings. In the drawings, the same or corresponding parts are denoted by the same reference numerals and description thereof will not be repeated.

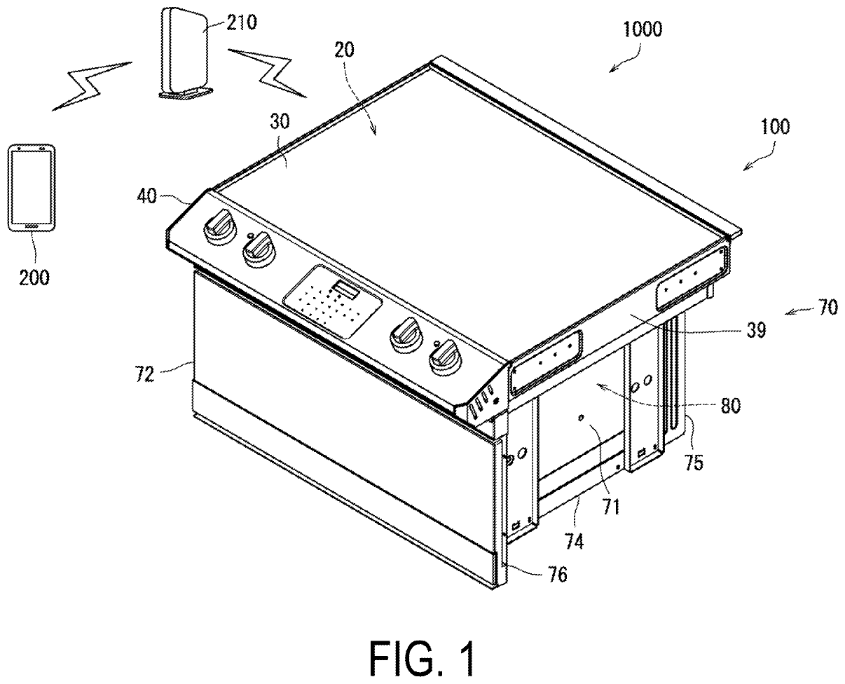

A microwave/grill system 1000 according to the present embodiment will be described with reference to FIG. 1. FIG. 1 is a diagram illustrating the microwave/grill system 1000 according to the present embodiment. As illustrated in FIG. 1, the microwave/grill system 1000 includes a microwave/grill apparatus 100, an external device, and a smartphone 200. The microwave/grill apparatus 100 is an example of a “heating cooker”. FIG. 1 illustrates an appearance of the microwave/grill apparatus 100 as seen obliquely from upper right.

The external device includes, for example, a Wi-Fi router 210. The Wi-Fi router 210 is located, for example, at a location away from the microwave/grill apparatus 100. The Wi-Fi router 210 is disposed, for example, in a room different from that in which the microwave/grill apparatus 100 is disposed. The Wi-Fi router 210 wirelessly communicates with, for example, the microwave/grill apparatus 100. The Wi-Fi router 210 wirelessly communicates with, for example, the smartphone 200.

The microwave/grill apparatus 100 is box-shaped. The microwave/grill apparatus 100 is disposed, for example, in a kitchen. The microwave/grill apparatus 100 cooks a first object H1 to be heated with heat. The first object H1 to be heated is, for example, a pot containing food. Specifically, the first object H1 to be heated is placed on an upper surface of the microwave/grill apparatus 100 and grilled. The microwave/grill apparatus 100 also cooks a second object H2 to be heated with heat. The second object H2 to be heated is, for example, a dish with food placed thereon. Specifically, the second object H2 to be heated is accommodated in the microwave/grill apparatus 100 and cooked with microwaves.

The microwave/grill apparatus 100 includes a heating unit 20, a grill chamber 39, a microwave heating cooking chamber 70, a microwave supply unit 89, and an operation unit 40.

In the present embodiment, a side of the microwave/grill apparatus 100 at which the operation unit 40 is disposed is defined as a front side of the microwave/grill apparatus 100 and the opposite side is defined as a rear side of the microwave/grill apparatus 100. Also, the right side of the microwave/grill apparatus 100 as viewed from the front is defined as a right side of the microwave/grill apparatus 100 and the opposite side is defined as a left side of the microwave/grill apparatus 100. These orientations do not limit the orientation of the microwave/grill apparatus 100 of the disclosure when used.

The microwave heating cooking chamber 70 is box-shaped. Specifically, the microwave heating cooking chamber 70 includes a right wall 71, a left wall 72, an upper wall (not illustrated), a lower wall 74, a rear wall 75, and a front door 76.

The front door 76 is a substantially rectangular plate-like member. The front door 76 can open and close a front opening of the microwave heating cooking chamber 70. Specifically, the front door 76 moves between a closed position and an open position. The open position indicates a position at which the front door 76 has opened the opening. On the other hand, the closed position indicates a position at which the front door 76 covers the opening.

When the front door 76 opens the opening, the second object H2 to be heated can be moved between the inside and the outside of the microwave heating cooking chamber 70. On the other hand, with the front door 76 covering the opening, the second object H2 to be heated is accommodated in the microwave heating cooking chamber 70.

The microwave supply unit 89 supplies microwaves into the microwave heating cooking chamber 70. Specifically, the microwave supply unit 89 includes a radiation chamber, a magnetron, a waveguide, a rotary antenna, and an antenna motor. The magnetron generates microwaves. The waveguide propagates microwaves generated by the magnetron to the radiation chamber. The rotary antenna is accommodated in the radiation chamber. The antenna motor drives the rotary antenna. The rotary antenna agitates and supplies the microwaves into the microwave heating cooking chamber 70.

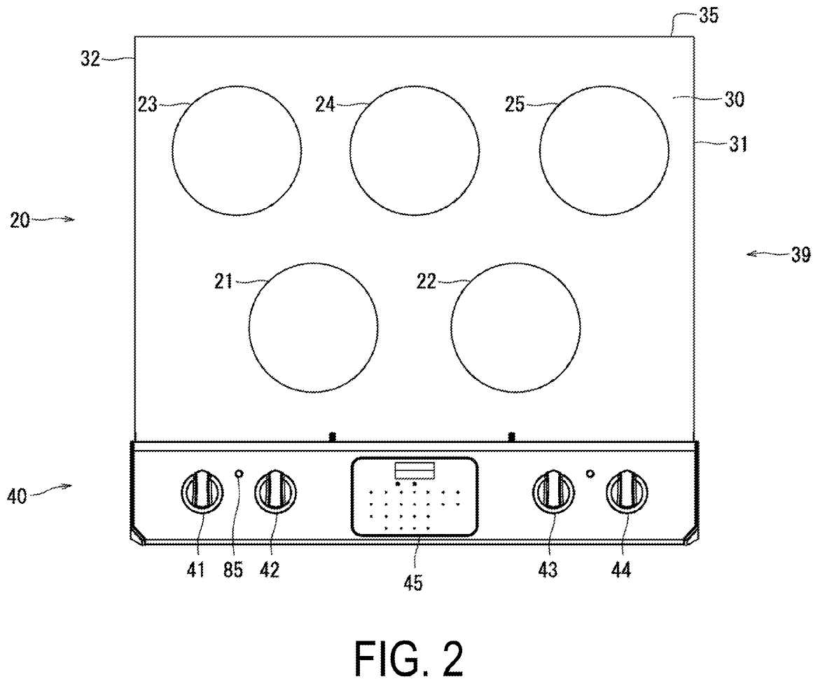

Next, the grill chamber 39, the heating unit 20, and the operation unit 40 will be described with reference to FIG. 1 and FIG. 2. FIG. 2 is a plan view illustrating an appearance of the microwave/grill apparatus 100 according to the present embodiment. As illustrated in FIG. 1 and FIG. 2, the heating unit 20 cooks the first object H1 to be heated with microwaves.

The grill chamber 39 is box-shaped. Specifically, the grill chamber 39 includes a plate 30, a right wall 31, a left wall 32, a lower wall (not illustrated), and a rear wall 35. The grill chamber 39 is provided above the microwave heating cooking chamber 70.

The plate 30 is a substantially rectangular plate-like member. The material of the plate 30 is, for example, glass. The first object H1 to be heated is placed on the plate 30.

The heating unit 20 is disposed inside the grill chamber 39. Namely, the plate 30 is provided above the heating unit 20.

The heating unit 20 includes a plurality of radiant heaters. Specifically, the heating unit 20 includes a first radiant heater 21, a second radiant heater 22, a third radiant heater 23, a fourth radiant heater 24, and a fifth radiant heater 25. Each of the first radiant heater 21, the second radiant heater 22, the third radiant heater 23, the fourth radiant heater 24, and the fifth radiant heater 25 applies a direct current to a nichrome wire to generate heat. Each of the first radiant heater 21, the second radiant heater 22, the third radiant heater 23, the fourth radiant heater 24, and the fifth radiant heater 25 has an annular shape.

The first radiant heater 21 and the second radiant heater 22 are disposed in front of the third radiant heater 23, the fourth radiant heater 24, and the fifth radiant heater 25. The second radiant heater 22 is disposed on the right side of the first radiant heater 21. The fourth radiant heater 24 is disposed on the right side of the third radiant heater 23. The fifth radiant heater 25 is disposed on the right side of the fourth radiant heater 24.

Operation information is input through the operation unit 40. The operation information includes, for example, information for turning on/off the power of each of the radiant heaters, adjusting the output of each of the radiant heaters, turning on/off the power of the microwave supply unit 89, or adjusting the output of the microwave supply unit 89. The operation unit 40 is disposed in front of the grill chamber 39. The operation unit 40 is disposed in front of the plate 30. The operation unit 40 is disposed above the front door 76.

The operation unit 40 includes a first dial 41, a second dial 42, a third dial 43, a fourth dial 44, and an operation panel 45. Specifically, the first dial 41 is operated by the cook to receive operation information of the first radiant heater 21. The second dial 42 is operated by the cook to receive operation information of the third radiant heater 23. The third dial 43 is operated by the cook to receive operation information of the fourth radiant heater 24. The fourth dial 44 is operated by the cook to receive operation information of the fifth radiant heater 25.

The operation panel 45 is operated by the cook to receive operation information of the second dial 42 or the microwave supply unit 89. Specifically, the operation panel 45 includes various keys and a display unit. The display unit displays various information. The display unit includes a liquid crystal panel.

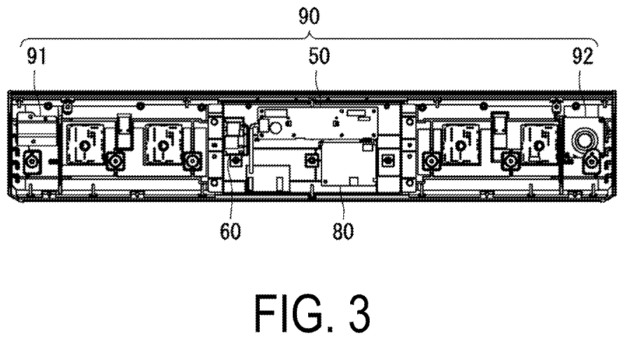

Next, the operation unit 40 and the communication unit 60 will be described with reference to FIG. 1 and FIG. 3. FIG. 3 is a diagram illustrating a rear side of the operation unit 40 according to the present embodiment. As illustrated in FIG. 1 and FIG. 3, the microwave/grill apparatus 100 further includes blowers 90 and a communication unit 60.

The blowers 90 blow air toward the heating unit 20. The blowers 90 include a first blower 91 and a second blower 92. The blowers 90 are located at both ends of the rear surface of the operation unit 40.

The communication unit 60 wirelessly communicates with the external device. Wireless includes, for example, near field communication. Specifically, wireless includes, for example, Wi-Fi communication.

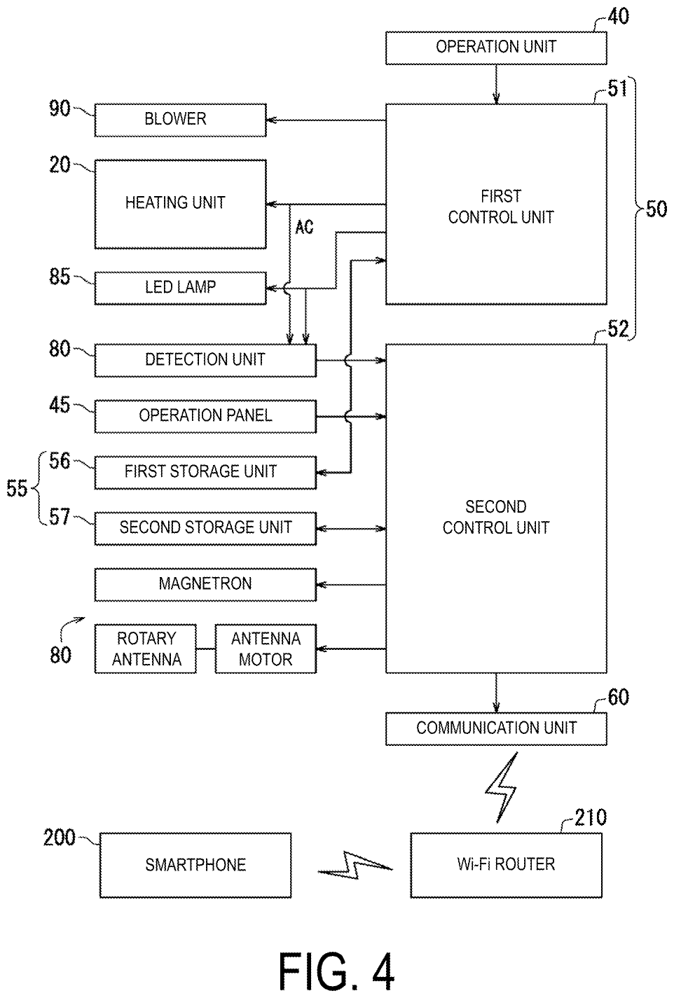

Next, the control unit 50 will be described with reference to FIG. 3 and FIG. 4. FIG. 4 is a block diagram illustrating a configuration of the microwave/grill apparatus 100 according to the present embodiment. As illustrated in FIG. 3 and FIG. 4, the microwave/grill apparatus 100 further includes control units 50, storage units 55, a detection unit 80, and a light-emitting diode (LED) lamp 85.

The storage units 55 include a first storage unit 56 and a second storage unit 57. The first storage unit 56 is composed of a random access memory (RAM) and a read only memory (ROM). The first storage unit 56 stores a control program for controlling the operation of each part of the microwave/grill apparatus 100. The second storage unit 57 is composed of a RAM and a ROM. The second storage unit 57 stores a control program for controlling the operation of each part of the microwave/grill apparatus 100.

The control units 50 include a first control unit 51 and a second control unit 52. The first control unit 51 is a hardware circuit including a processor such as a central processing unit (CPU). The first control unit 51 executes the control program stored in the first storage unit 56.

The first control unit 51 executes the control program stored in the first storage unit 56 to control the heating unit 20, the blowers 90, and the LED lamp 85. Specifically, the cook inputs operation information through the operation unit 40. The first control unit 51 outputs drive information to the heating unit 20 and the blowers 90 based on the operation information. For example, the first control unit 51 repeatedly turns the power of the first radiant heater 21 on for a first predetermined period and off for a second predetermined period. The first control unit 51 also outputs the drive information to the detection unit 80.

Further, the first control unit 51 determines whether the temperature of the plate 30 is at a predetermined temperature or higher. For example, the first control unit 51 determines whether the temperature of the plate 30 is at a predetermined temperature or higher based on the detection result of a temperature sensor disposed at the plate 30. The first control unit 51 outputs the drive information to the LED lamp 85 and the detection unit 80.

The LED lamp 85 displays the determination result of the first control unit 51. The LED lamp 85 is located at a front surface of the operation unit 40. When the temperature of the plate 30 is at the predetermined temperature or higher, the LED lamp 85 lights up. On the other hand, when the temperature of the plate 30 is below the predetermined temperature, the LED lamp 85 is off.

The detection unit 80 outputs the drive information received from the first control unit 51 to the second control unit 52. Specifically, the detection unit 80 outputs the drive state of each of the plurality of radiant heaters to the second control unit 52. For example, the detection unit 80 outputs a current of 0.1 V to the second control unit 52 when the first radiant heater 21 is being driven. The detection unit 80 outputs a current of 0.3 V to the second control unit 52 when the second radiant heater 22 is being driven. Further, the detection unit 80 outputs a current of 0.4 V to the second control unit 52 when the first radiant heater 21 and the second radiant heater 22 are being driven.

The second control unit 52 is a hardware circuit including a processor such as a CPU. The second control unit 52 executes the control program stored in the second storage unit 57.

The second control unit 52 executes the control program stored in the second storage unit 57 to control the microwave supply unit 89. Specifically, the cook inputs operation information through the operation panel 45. The second control unit 52 controls the microwave supply unit 89 based on the operation information. For example, the second control unit 52 turns the power of the microwave supply unit 89 on for a third predetermined period.

The second control unit 52 also controls the communication unit 60 to transmit the drive information to the external device. Specifically, the Wi-Fi router 210 receives the drive information from the communication unit 60. The Wi-Fi router 210 then transmits the drive information to the smartphone 200. The drive information includes the drive state of the heating unit 20. The drive information may include the determination result of the first control unit 51.

Specifically, the drive information indicates that the temperature of the plate 30 is at the predetermined temperature or higher. The drive information may further include the drive state of each of the plurality of radiant heaters. The drive information may further include the number of radiant heaters being driven, the on/off of the power of each of the radiant heaters, or the on/off of the power of the blowers 90. The drive information may further include the drive state of the microwave supply unit 89.

The control unit 50 controls the communication unit 60 to transmit the drive information to the external device as described above. As a result, the cook can identify the drive information through the external device. That is, the cook can identify the state of the microwave/grill apparatus 100 even if being away from the microwave/grill apparatus 100 during cooking.

The drive information also indicates that the temperature of the plate 30 is at the predetermined temperature or higher. As a result, the cook can identify that the temperature of the plate 30 is at the predetermined temperature or higher. Thus, the cook can go to the location of the microwave/grill apparatus 100 and deal with the microwave/grill apparatus 100.

The drive information further includes the drive state of each of the plurality of radiant heaters. As a result, the cook can identify the drive information through the external device. That is, the cook can identify the state of the microwave/grill apparatus 100 even if being away from the microwave/grill apparatus 100 during cooking.

The drive information further includes the number of radiant heaters being driven, the on/off state of the power of each of the radiant heaters, or the on/off state of the power of the blowers 90. As a result, the cook can identify the drive information through the external device. That is, the cook can identify the state of the microwave/grill apparatus 100 even if being away from the microwave/grill apparatus 100 during cooking.

The second control unit 52 may not transmit the off state of the power of the first radiant heater 21 during a period from the time when the power of the first radiant heater 21 is turned off to the time when the sum of the second predetermined period and the first predetermined period has elapsed. As a result, even if the power of the first radiant heater 21 is repeatedly turned on for the first predetermined period and off for the second predetermined period, erroneous recognition by the cook that the power of the first radiant heater 21 has been turned off can be avoided.

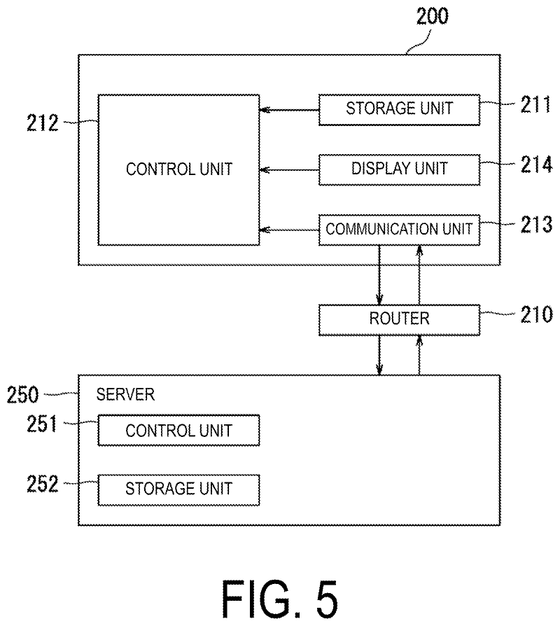

Next, the smartphone 200 will be described with reference to FIG. 5. FIG. 5 is a block diagram illustrating a configuration of the smartphone 200. The smartphone 200 is carried by the cook.

Specifically, the smartphone 200 includes a storage unit 211, a control unit 212, a communication unit 213, and a display unit 214 as illustrated in FIG. 5.

The storage unit 211 is an example of a non-transitory computer-readable recording medium with programs recorded therein. Specifically, the storage unit 211 includes a storage device and stores an application program (hereinafter sometimes referred to as an “application AP”), a computer program, and data. Specifically, the storage unit 211 includes a main storage device such as a semiconductor memory and an auxiliary storage device such as a semiconductor memory, a solid state drive, and/or a hard disk drive. The storage unit 211 may also include a removable medium.

The application AP is, for example, a computer program that causes the display unit 214 to display the drive information. In the present embodiment, the application AP is downloaded from a server 250 to the smartphone 200 and installed on the smartphone 200. The server 250 includes a control unit 251 and a storage unit 252. The control unit 251 includes a processor such as a CPU. The storage unit 252 is an example of a non-transitory computer-readable recording medium with programs recorded therein. Specifically, the storage unit 252 includes a storage device and stores an application AP, a computer program, and data. Specifically, the storage unit 252 includes a main storage device such as a semiconductor memory and an auxiliary storage device such as a semiconductor memory, a solid state drive, and/or a hard disk drive. The storage unit 252 may also include a removable medium.

The control unit 212 includes a processor such as a CPU. The control unit 212 controls each component of the smartphone 200. Specifically, the control unit 212 executes the computer program and the application AP stored in the storage unit 211 to control the communication unit 213 and the display unit 214.

The communication unit 213 performs wireless communication with the Wi-Fi router 210. The communication unit 213 includes, for example, a network interface controller (NIC) that performs communication according to a predetermined communication protocol or a communication module that performs communication conforming to a Wi-Fi communication standard. The communication unit 213 may include a wireless communication module that performs wireless communication. Specifically, the communication unit 213 receives the drive information. That is, the application AP causes receiving the drive information of the microwave/grill apparatus 100 to be performed.

The display unit 214 is, for example, a touch panel. Specifically, the display unit 214 is a liquid crystal display or an organic electroluminescence display. Specifically, the display unit 214 displays the drive information. That is, the application AP causes displaying the drive information of the microwave/grill apparatus 100 to be performed.

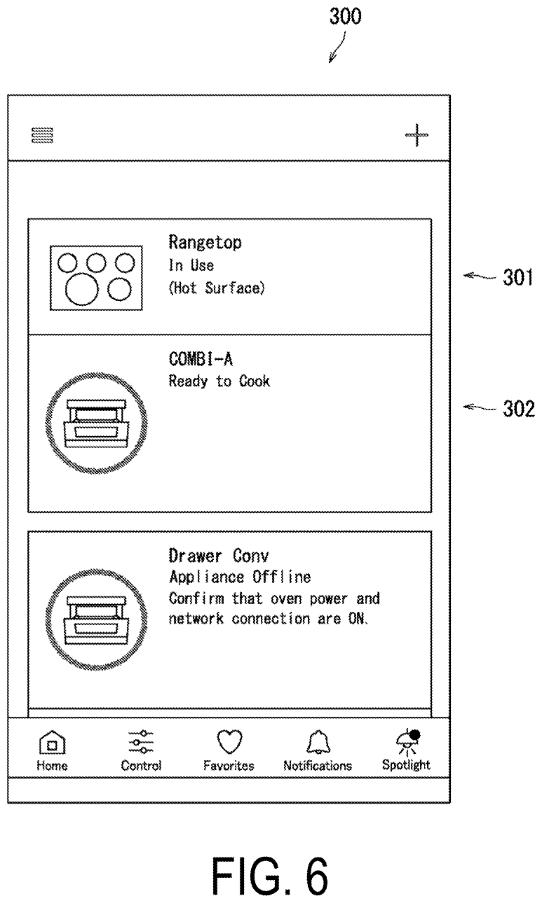

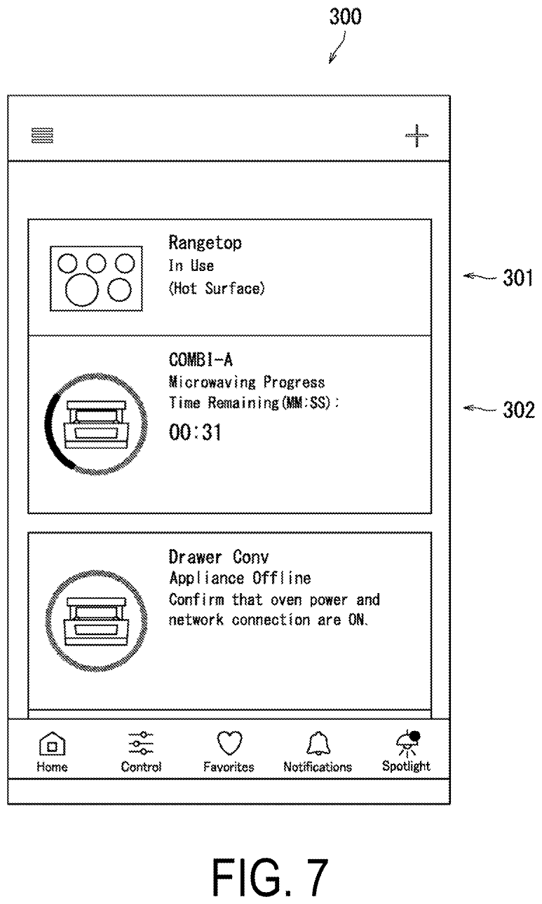

Next, examples of a display image 300 displayed on the smartphone 200 will be described with reference to FIG. 6 and FIG. 7. FIG. 6 and FIG. 7 are diagrams illustrating examples of the display image 300 displayed on the smartphone 200. FIG. 6 is a diagram illustrating an example of the display image 300 with the heating unit 20 being driven. FIG. 7 is a diagram illustrating an example of the display image 300 with the heating unit 20 and the microwave supply unit 89 being driven.

As illustrated in FIG. 6 and FIG. 7, the display image 300 is divided into a first display area 301 and a second display area 302.

A plan view of the microwave/grill apparatus 100 is displayed at a left portion of the first display area 301. Drive information of the heating unit 20 is displayed at a right portion of the first display area 301. The drive information indicates the determination result of the first control unit 51. Specifically, a message indicating that the temperature of the plate 30 is at the predetermined temperature or higher is displayed when the temperature of the plate 30 is at the predetermined temperature or higher. On the other hand, no message is displayed when the temperature of the plate 30 is below the predetermined temperature. The drive information further includes the drive state of the heating unit 20. Specifically, a message indicating that the heating unit 20 is being driven is displayed when the heating unit 20 is being driven. On the other hand, a message indicating that the heating unit 20 is not being driven is displayed when the heating unit 20 is not being driven.

A front view of the microwave/grill apparatus 100 is displayed at a left portion of the second display area 302. Drive information of the microwave supply unit 89 is displayed at a right portion of the second display area 302. Specifically, a message indicating the time for which the microwave supply unit 89 has been driven is displayed when the microwave supply unit 89 is being driven. On the other hand, a message indicating that driving of the microwave supply unit 89 has been ended is displayed when driving of the microwave supply unit 89 has been ended.

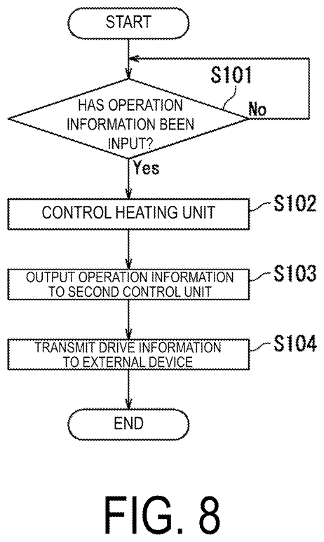

Next, a heating cooking method using the microwave/grill apparatus 100 of the present embodiment will be described with reference to FIG. 8. FIG. 8 is a flowchart for explaining the heating cooking method using the microwave/grill apparatus 100.

In step S101, the first control unit 51 determines whether operation information has been input to the microwave/grill apparatus 100.

When the first control unit 51 determines in step S101 that no operation information has been input to the microwave/grill apparatus 100, the processing returns to step S101.

On the other hand, when the first control unit 51 determines in step S101 that operation information has been input to the microwave/grill apparatus 100, the processing proceeds to step S102.

In step S102, the first control unit 51 controls the heating unit 20 based on the operation information.

Next, in step S103, the first control unit 51 outputs drive information to the second control unit 52.

Next, in step S104, the second control unit 52 transmits the drive information of the microwave/grill apparatus 100 to the external device. Then, the heating cooking method ends.

According to the present embodiment, the control unit 50 controls the communication unit 60 to transmit the drive information to the external device as described above with reference to FIG. 8. As a result, the cook can identify the drive information through the external device. That is, the cook can identify the state of the microwave/grill apparatus 100 even if being away from the microwave/grill apparatus 100 during cooking.

An embodiment of the disclosure has been described above with reference to the drawings. However, the disclosure is not limited to the above embodiment and can be embodied in various modes without departing from the spirit of the disclosure. To facilitate understanding of the disclosure, the drawings schematically illustrate each component emphasized and the thickness and length of each component illustrated, the number of components illustrated, and the like differ from the actual ones for convenience of drawing. The material, shape, dimensions, and the like of each component illustrated in the above embodiment are examples and are not particularly limited and various modifications are possible without substantially departing from the effects of the disclosure.

(1) The microwave/grill apparatus 100 includes the microwave supply unit 89 as described with reference to FIG. 1 to FIG. 8, but the disclosure is not limited to this. The microwave/grill apparatus 100 may include a grill heater.

(2) In the microwave/grill apparatus 100, the communication unit 60 communicates with the Wi-Fi router 210, but the disclosure is not limited to this. For example, the communication unit 60 may communicate with the smartphone 200 via infrared communication or Bluetooth (trademark).

### INDUSTRIAL APPLICABILITY

The disclosure is useful, for example, in the field of heating cookers.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A heating cooker comprising:
a heating unit configured to heat a first object to be heated;
a plate provided above the heating unit, the first object to be heated being to be placed on the plate;
an operation unit through which operation information is input;
a control unit configured to control the heating unit based on the operation information; and
a communication unit configured to wirelessly communicate with an external device,
wherein the control unit controls the communication unit to transmit drive information to the external device, and
the drive information includes a drive state of the heating unit.

2. The heating cooker according to claim 1,
wherein the control unit determines whether a temperature of the plate is at a predetermined temperature or higher, and
the drive information includes a determination result of the control unit.

3. The heating cooker according to claim 1,
wherein the heating unit includes a plurality of radiant heaters,
a material of the plate is glass, and
the drive information further includes a drive state of each of the plurality of radiant heaters.

4. The heating cooker according to claim 3, further comprising
a blower configured to blow air toward the heating unit,
wherein the drive information further includes the number of radiant heaters being driven of the plurality of radiant heaters, an on/off state of power of each of the plurality of radiant heaters, or an on/off state of power of the blower.

5. The heating cooker according to claim 3, further comprising:
a heating cooking chamber provided below the heating unit and configured to accommodate a second object to be heated; and
a microwave supply unit configured to supply microwaves into the heating cooking chamber,
wherein the control unit includes
a first control unit configured to control the heating unit based on the operation information, and
a second control unit configured to control the microwave supply unit based on the operation information, and
the second control unit controls the communication unit to transmit the drive information to the external device.

6. A non-transitory computer-readable recording medium storing a computer program, the computer program being configured to cause a computer to perform:
receiving the drive information of the heating cooker according to claim 1; and
displaying the drive information.

7. A heating cooking method for a heating cooker including a heating unit configured to heat a first object to be heated and a plate provided above the heating unit, the first object to be heated being to be placed on the plate, the heating cooking method comprising:
inputting operation information to the heating cooker;
controlling the heating unit based on the operation information; and
transmitting drive information to an external device from the heating cooker,
wherein the drive information includes a drive state of the heating unit.
